(19) United States
(12) Patent Application Publication
(10) Pub. No.: US 2026/0088998 A1
(43) Pub. Date: Mar. 26, 2026

(54) Modular Reduction for Cryptographic Operations

(71) Applicant: Infineon Technologies AG, Neubiberg (DE)

(72) Inventor: Wieland Fischer, München (DE)

(21) Appl. No.: 19/338,586

(22) Filed: Sep. 24, 2025

(30) Foreign Application Priority Data
Sep. 26, 2024 (DE) 102024209343.2

(51) Int. Cl. H04L 9/30

(52) U.S. Cl. CPC H04L 9/3006

(57) ABSTRACT

Performing a modular reduction of an input number C modulo of a modulus N. An example method comprises: (i) calculating an intermediate value q, from which a quotient of the input number C divided by the modulus N is approximated, (ii) extracting a number Q for a reduction operation C−Q·N from the intermediate value q, (iii) extracting information from the intermediate value q, wherein on the basis of the information already before performing the reduction operation C−Q·N it is possible to determine whether a final reduction is to be performed, (iv) performing the reduction operation C−Q·N, and (v) depending on the information, performing the final reduction or not performing the final reduction.

### TECHNICAL FIELD

The present disclosure is generally related to cryptographic circuits, and is more particular related to techniques for carrying out modular reductions I such circuits.

### BACKGROUND

Present approaches relate to modular reductions for cryptographic methods. By way of example, the so-called Barrett reduction is used as a modular reduction. Solution approaches described here are based in particular on the known Barrett reduction. Cryptographic methods are used in cryptographic modules or crypto-systems. The cryptographic methods allow the encryption and decryption of data and also the creation and verification of digital signatures. Examples of cryptographic methods are: RSA methods, ECC methods (crypto-systems based on elliptic curves), signature methods (e.g. DSA, ECDSA, etc.).

### SUMMARY

The object consists in particular in improving known approaches and in particular providing a more efficient possibility for performing a modular reduction in particular in the context of a cryptographic method.

This object is achieved according to the features of the independent claims. Preferred embodiments can be gathered from the dependent claims, in particular.

The examples proposed herein can be based on at least one of the following solutions. In particular, combinations of the following features can be used in order to achieve a desired result. The features of the device can be combined with features of the method, or vice versa.

For solution purposes, for example a device is specified for performing a modular reduction of an input number C modulo of a modulus N, wherein the device comprises a processing unit configured for
calculating an intermediate value q, from which a quotient of the input number C is approximated by the modulus N,
extracting a number Q for a reduction operation C−Q·N from the intermediate value q,
extracting information from the intermediate value q, wherein on the basis of the information already before performing the reduction operation C−Q·N it is possible to determine whether a final reduction is to be performed,
performing the reduction operation C−Q·N,
depending on the information, performing the final reduction or not performing the final reduction.

In this case, it should be noted that from the intermediate value q (which does not already correspond to the rational quotient C/N) it is not just possible to derive the integral quotient Q required for determining C−Q·N, rather in most cases the intermediate value q already yields an indication of whether Q is the correct quotient or whether Q is too small by 1. It is only in the last case that the final reduction is required. Consequently, it is firstly an advantage that it is already known at an early stage whether the final reduction is still to be performed, and secondly it is an advantage that the final reduction is necessary only extremely infrequently on account of the mapping into the space of rational numbers.

One advantage of the approach described here consists in making it possible, on account of the increase in efficiency, for example to effect rapid performance or performance with reduced energy consumption in a processing unit, e.g., a processor or a crypto-module (comprising e.g. one or more processors). This is advantageous especially for time-critical applications.

In one development, the processing unit is configured for performing a cryptographic operation, in particular an encryption, a decryption, a signature creation and/or a signature verification.

In one development, the processing unit comprises one of the following or is embodied as one of the following:
a processor,
a chip,
a crypto-module.

In one development, the processing unit is configured to carry out the modular reduction as part of a modular multiplication.

In one development,
the modulus N has a number of m words and the input number C is at most 0<d words longer than the modulus N,
wherein the intermediate value q is determined by calculating elementary products Cᵢ and Iⱼ where i+j>m+d−1, wherein Cᵢ is an i-valued word from the input number C and Iⱼ is a j-valued word from a value I, wherein the value I is determined according to

W^{m+d+1}/N

or an integral multiple thereof, wherein W=2ⁿ holds true and n is a word width.

In one development, the processing unit is configured for extracting the information, wherein the information corresponds to the Boolean value of the logical condition

$$q 1 \geq W - d - 3$$

or of a logically weaker condition.

For example, the condition

$$q 1 \geq W - d - 5$$

is a logically weaker condition, or a “logical attenuation,” of the condition

$$q 1 \geq W - d - 3 .$$

If the respective condition is met, the cases for which the final reduction is required can be detected. The greater the weakening of the logical condition, the higher the probability that the final reduction was performed unnecessarily.

In one development, the processing unit is configured for performing the final reduction if the Boolean value of the logical condition or of the logically weaker condition is true.

Furthermore, a method is specified for performing a modular reduction of an input number C modulo of a modulus N, comprising the steps of:
calculating an intermediate value q, from which a quotient of the input number C is approximated by the modulus N,
extracting a number Q for a reduction operation C−Q·N from the intermediate value q,
extracting information from the intermediate value q, wherein on the basis of the information already before performing the reduction operation C−Q·N it is possible to determine whether a final reduction is to be performed,
performing the reduction operation C−Q·N,
depending on the information, performing the final reduction or not performing the final reduction.

In one development, the modular reduction is performed as part of a modular multiplication.

In one development,
the modulus N has a number of m words and the input number C is at most 0<d words longer than the modulus N,
the intermediate value q is determined by calculating elementary products Cᵢ and Iⱼ where i+j>m+d−1, wherein Cᵢ is an i-valued word from the input number C and Iⱼ is a j-valued word from a value I, wherein the value I is determined according to

$${W}^{m + d + 1} / N$$

or an integral multiple thereof, wherein W=2ⁿ holds true and n is a word width.

In one development, the information corresponds to a Boolean value

$$q 1 \geq W - d - 3$$

or of a logically weaker condition.

In one development, the final reduction is performed if the Boolean value of the logical condition or of the logically weaker condition is true.

In one development, the modular reduction is used in a cryptographic method or a cryptographic system.

In one development, the modular reduction is performed in the context of a cryptographic operation comprising:
an encryption,
a decryption,
a signature creation,
a signature verification.

The above-described properties, features and advantages of this invention and the way in which they are achieved will be described below in association with a schematic description of exemplary embodiments which will be explained in greater detail in association with the drawings. In this case, identical or identically acting elements may be provided with identical reference signs for the sake of clarity.

### BRIEF DESCRIPTION OF THE FIGURES

FIG. 1 shows one exemplary notation for implementing the known Barrett reduction.

FIG. 2 shows a notation of one exemplary implementation of an optimized Barrett reduction.

FIG. 3 shows a table for illustrating the reduced complexity of the optimized Barrett reduction in comparison with the known Barrett reduction.

FIG. 4 shows by way of example an arrangement comprising a processing unit which provides a cryptographic output depending on an input.

FIG. 5 shows a processing device for implementing a cryptographic solution by means of at least one crypto-module.

### DETAILED DESCRIPTION

The Barrett reduction is used in cryptographic circuits, for example for implementing modular multiplications. In general, the Barrett reduction is an operation

$$D := A \cdot B mod N$$

wherein N is a positive integer and A, B∈[0, N[holds true. The expression D denotes that uniquely defined integer from the interval [0, N[such that A·B−D is divisible by N.

Accordingly, D can also be defined as follows:

$$D = A \cdot B - Q \cdot N \qquad ( 1 )$$

$$where$$

$$Q := ⌊ \frac{A \cdot B}{N} ⌋ .$$

In this case, the brackets └ ┘ denote the floor function. The largest multiple of N which is still just less than or equal to this number is subtracted from A·B. If it holds true that

$$A \cdot B = ( \frac{A \cdot B}{N} ) \cdot N$$

Q is precisely the largest integral factor which forms this multiple.

An explanation is given below of how the modular multiplication can be implemented on a processor with the word width w. In particular, the way in which Q can be calculated is explained.

The following notations are applicable:
W is the base of the number representation.
W=2^{w}: if the base is of a power of two, which is assumed by way of example below, then w is the word width (e.g. bit width of a processor word) of the number representation. Exemplary values for w are 8, 16, 32 or 64, but also 1 if the binary representation is generally considered.
The modulus N has a length of exactly 1≤m words. It is assumed by way of example that

$${W}^{m - 1} < N < {W}^{m}$$

holds true.

### Approximation of Rational Quotients and Integer Quotients

By way of example, the product A·B is more generally replaced by a value C where

$$0 < C < N \cdot {W}^{d} , \qquad ( 2 )$$

for an integer 0<d≤m. Consequently, in particular d=m also holds true. In this case, C<N² could be assumed and some of the following estimations could be formulated more precisely.

Therefore, it holds true that:

$$Q := ⌊ \frac{C}{N} ⌋ < {W}^{d} . \qquad ( 3 )$$

Q thus maximally has the word length d.

A rational quotient

$$q := \frac{C}{N} \qquad ( 4 )$$

can also be written as follows:

$$q = \frac{C}{{W}^{m}} \cdot \frac{{W}^{m + d}}{N} \cdot \frac{1}{{W}^{d}} . \qquad ( 5 )$$

This tautology is meaningful since the first two factors are of the order of magnitude of W^{d}: if the quotient of two numbers C and N is of the order of magnitude of W^{d}, then this is substantially determined by the upper d words of C and N (or =1/N)). The integral proportion of

$$\frac{C}{{W}^{m}}$$

consists exactly of these d words.

Thus a first approximation q₁ for q results as

$${q}_{1} = ⌊ \frac{C}{{W}^{m}} ⌋ \cdot ⌊ \frac{{W}^{m + d}}{N} ⌋ \cdot \frac{1}{{W}^{d}} \qquad ( 6 )$$

and hence there follows as a first approximation Q₁ for Q

$${Q}_{1} = ⌊ ⌊ \frac{C}{{W}^{m}} ⌋ \cdot ⌊ \frac{{W}^{m + d}}{N} ⌋ \cdot \frac{1}{{W}^{d}} ⌋ . \qquad ( 7 )$$

This is especially advantageous if integers are to be employed for computation.

The following is applicable in a more general formulation: if C₁ is an approximation for

$$\frac{C}{{W}^{m}}$$

and I₁ is an approximation for

$$\frac{{W}^{m + d}}{N} ,$$

then

$${q}_{1} = \frac{{C}_{1} \cdot {I}_{1}}{{W}^{d}} and {Q}_{1} = ⌊ \frac{{C}_{1} \cdot {I}_{1}}{{W}^{d}} ⌋ \qquad ( 8 )$$

are an approximation for q and Q, respectively.

What is in question then is the extent to which q₁ deviates from the exact value q. This depends on the extent to which C₁ deviates from

$$\frac{C}{{W}^{m}}$$

and I₁ deviates from

$$\frac{{W}^{m + d}}{N} :$$

Proceeding from

$${C}_{1} = \frac{C}{{W}^{m}} - γ$$

$$and$$

$${I}_{1} = \frac{{W}^{m + d}}{N} - v$$

where 0≤γ,ν the following holds true:

$$0 \leq q - {q}_{1} < γ \cdot \frac{{W}^{m}}{N} + v \cdot \frac{N}{{W}^{m}} . \qquad ( 9 )$$

It thus holds true that

$$0 \leq Q - {Q}_{1} < γ \cdot \frac{{W}^{m}}{N} + v \cdot \frac{N}{{W}^{m}} + 1. \qquad ( 10 )$$

Explanation: in the first inequality, q₁ was calculated with the values C₁, I₁ instead of with the exact rational values. On account of the assumption 0≤γ,ν, the values are smaller than the exact values and, consequently, q₁ cannot be greater than q.

The following transformation holds true:

$$q - {q}_{1} = \frac{C}{N} - ( ( \frac{C}{{W}^{m}} - γ ) ( \frac{{W}^{m + d}}{N} - v ) \frac{1}{{W}^{d}} ) = γ \frac{{W}^{m}}{N} + v \frac{c}{{W}^{m + d}} - \frac{γ \cdot v}{{W}^{d}} < γ \frac{{W}^{m}}{N} + v \frac{N \cdot {W}^{d}}{{W}^{m + d}} \leq γ \frac{{W}^{m}}{N} + v \frac{N}{{W}^{m}} .$$

The last inequality follows directly from Q₁=└q₁┘ and Q=└q┘.

It thus follows that: for the approximation

$${Q}_{1} = ⌊ ⌊ \frac{C}{{W}^{m}} ⌋ \cdot ⌊ \frac{{W}^{m + d}}{N} ⌋ \cdot \frac{1}{{W}^{d}} ⌋$$

it holds true that γ,ν<1^{γ,ν<1} and thus

$$0 \leq Q - {Q}_{1} < \frac{{W}^{m}}{N} + \frac{N}{{W}^{m}} + 1 < W + 2 . \qquad ( 11 )$$

For the case W=2, for the approximation it holds true that

$${Q}_{1} = ⌊ ⌊ \frac{C}{{2}^{m}} ⌋ \cdot ⌊ \frac{{2}^{m + d}}{N} ⌋ \cdot \frac{1}{{2}^{d}} ⌋$$

and thus

$$0 \leq Q - {Q}_{1} < 4 . \qquad ( 12 )$$

On the basis of equations (9) and (10), it is evident that the error γ influences the estimation with a larger factor than the error ν, since firstly it holds true that

$$1 < \frac{{W}^{m}}{N} < W$$

and secondly it holds true that

$$\frac{N}{{W}^{m}} < 1 .$$

For this reason, the error γ should be less than the error v.

By way of example,

$$γ \approx \frac{v}{W} \qquad ( 13 )$$

can be used. If more information about the specific modulus N is available, that information can be used accordingly.

If

$${C}_{1} = ⌊ \frac{c}{{W}^{m}} ⌋$$

is replaced by a more precise value

$${C}_{1} := ⌊ \frac{c}{{W}^{m - 1}} ⌋ \cdot \frac{1}{W} , \qquad ( 14 )$$

(which can be interpreted such that the first word after the decimal point is concomitantly taken into consideration), this gives rise to the following for the approximation

$${q}_{1} = \frac{{C}_{1} \cdot {I}_{1}}{{W}^{d}}$$

$$or$$

$${Q}_{1} = ⌊ \frac{{C}_{1} \cdot {I}_{1}}{{W}^{d}} ⌋$$

$$where$$

$${C}_{1} := ⌊ \frac{c}{{W}^{m - 1}} ⌋ \cdot \frac{1}{W}$$

$$and$$

$${I}_{1} := ⌊ \frac{{W}^{m + d}}{N} ⌋$$

where

$$γ < \frac{1}{W}$$

and v<1 and it therefore follows that

$$0 \leq q - {q}_{1} < \frac{1}{W} \frac{{W}^{m}}{N} + \frac{N}{{W}^{m}} < 1 + 1 = 2 \qquad ( 15 )$$

$$or$$

$$0 \leq Q - {Q}_{1} \leq q - {Q}_{1} < \frac{1}{W} \frac{{W}^{m}}{N} + \frac{N}{{W}^{m}} + 1 < 1 + 1 + 1 = 3. \qquad ( 16 )$$

This can also be formulated as follows:

$${Q}_{1} = ( ⌊ \frac{C}{{W}^{m - 1}} ⌋ \cdot ⌊ \frac{{W}^{m + d}}{N} ⌋ ) div {W}^{d + 1} ,$$

wherein the product in brackets is a product of integers. In this case, the first factor has a maximum length of d+1 words and the second factor comprises exactly d+1 words.

This result is the basis for the Barrett reduction, in which the result of the calculation C−Q₁·N has to be reduced with N at most 2 times in order to arrive at the end result. This follows directly from Q−Q₁<3, which is equivalent to Q−Q₁≤2.

In order to increase the precision for C₁ to the same extent as for I₁, the following arises for the approximation

$${q}_{1} = \frac{{C}_{1} \cdot {I}_{1}}{{W}^{d}}$$

$$or$$

$${Q}_{1} = ⌊ \frac{{C}_{1} \cdot {I}_{1}}{{W}^{d}} ⌋$$

$$where$$

$${C}_{1} := ⌊ \frac{C}{{W}^{m - 2}} ⌋ \cdot \frac{1}{{W}^{2}}$$

$$and$$

$${I}_{1} := ⌊ \frac{{W}^{m + d + 1}}{N} ⌋ \cdot \frac{1}{W}$$

where

$$γ < \frac{1}{{W}^{2}} and v < \frac{1}{W}$$

and it therefore follows that

$$0 \leq q - {q}_{1} < \frac{1}{{W}^{2}} \frac{{W}^{m}}{N} + \frac{1}{W} \frac{N}{{W}^{m}} < \frac{1}{W} + \frac{1}{{W}^{2}} < \frac{2}{W} \qquad ( 17 )$$

$$or$$

$$0 \leq Q - {Q}_{1} < \frac{1}{{W}^{2}} \frac{{W}^{m}}{N} + \frac{1}{W} \frac{N}{{W}^{m}} + 1 < \frac{2}{W} + 1. \qquad ( 18 )$$

This can also be formulated as follows:

$${Q}_{1} = ( ⌊ \frac{C}{{W}^{m - 2}} ⌋ \cdot ⌊ \frac{{W}^{m + d + 1}}{N} ⌋ ) {divW}^{d + 3} ,$$

wherein the product in brackets is a product of integers. In this case, the first factor has a maximum length of d+2 words and the second factor comprises exactly d+2 words.

Therefore, either 01=Q or 01=0-1 holds true.

It is evident here that q and qᵢ are quite close to one another. With

$$δ := q - {q}_{1} < 1 ,$$

it follows that

$$\{ \begin{matrix}{Q}_{1} = Q , & for q ∈ [ Q + δ , Q + 1 [ \\ {Q}_{1} = Q - 1 , & for q ∈ [ Q , Q + δ [\end{matrix} . \qquad ( 19 )$$

Proceeding from a heuristic approach, it follows that given randomly distributed numbers in W−2 of W cases q and qᵢ are so close together that Q=01 holds true. The condition can be reformulated on the basis of q₁: if

$$δ = q - {q}_{1} ∈ [ 0 , 1 [$$

then it holds true that

$$\{ \begin{matrix}{Q}_{1} = Q , & for {q}_{1} ∈ [ Q , Q + 1 - δ [ \\ {Q}_{1} = Q - 1 , & for {q}_{1} ∈ [ Q - δ , Q [\end{matrix} . \qquad ( 20 )$$

It is known here that

$$δ < \frac{2}{W} .$$

Consequently, from the condition

$${q}_{1} ∈ [ Q - δ , Q [ . \qquad ( 21 )$$

there follows the condition

$${q}_{1} ∈ [ Q - \frac{2}{W} , Q [ . \qquad ( 22 )$$

This last condition is advantageous because it is easily checkable as soon as q₁ has been calculated. Although this condition is not equivalent to the first condition, it too occurs only infrequently. In other words: if the last condition is not satisfied, then Q₁=Q holds true; by contrast, if the last condition is satisfied, there is a certain chance that Q₁=Q−1.

In order to check the condition, a fraction (i.e. a proportion after the decimal point) of q₁ is examined.

The examples below indicate how the Barrett reduction can be optimized more extensively.

Multiplication with Barrett Reduction

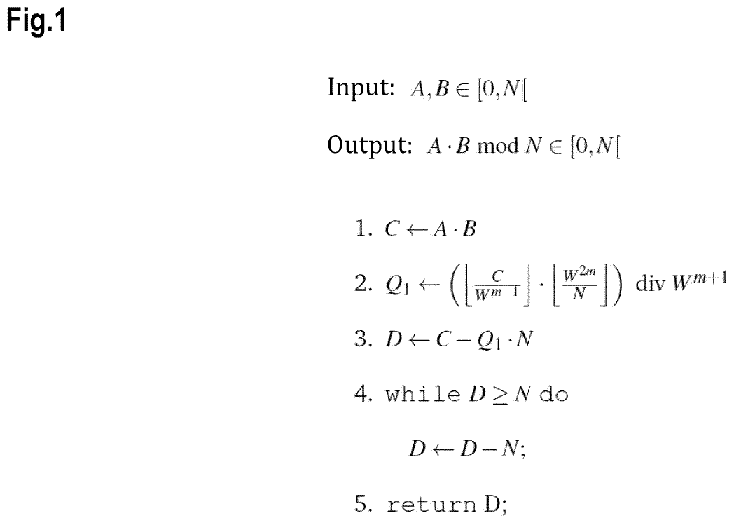

The Barrett reduction is used in particular for modular multiplications. FIG. 1 shows a diagram with one exemplary algorithm of a known Barrett reduction for d=m.

By way of example, the value

$${I}_{1} = ⌊ \frac{{W}^{2 m}}{N} ⌋$$

can be precalculated.

According to the above explanations, it follows that the subtractions according to the final reduction (step 4) is undergone a maximum of two times. Reference should additionally be made to [A. J. Menezes et al.: Handbook of Applied Cryptography, Second Edition, 1997, CRC Press LLC, Boca Raton, section 14.3.3 Barrett reduction, pages 603 and 604].

### Complexity of the Barrett Reduction

Hereinafter the case W=2 is excluded by way of example for the following complexity considerations, since real implementations usually use a larger architecture width.

The execution time or complexity of an implementation of the Barrett reduction depends for example on the architecture of the underlying platform on which the algorithm runs.

By way of example, the number of necessary elementary multiplications is assumed here as a measure of the complexity. An elementary multiplication (em) is a multiplication which is defined and executable as an individual operation on the respective platform. In the present case, these are intended to be multiplications with respect to the word width of the architecture, expressed by the mapping

$$mul : [ 0 , W [ \times [ 0 , W [ \to [ 0 , {W}^{2} [ , ( {A}_{i} , {B}_{j} ) ↦ {A}_{i} \cdot {B}_{j} . \qquad ( 23 )$$

In steps 2 to 5 of the Barrett reduction according to FIG. 1, the complexity is dominated by the multiplication of 2 numbers of the word lengths m+1 in step 2 and by the multiplication of 2 numbers of the word lengths m in step 3.

Besides the multiplications there are further factors which influence the complexity of an implementation. By way of example, the loading and storage behavior, linear operations (additions and subtractions) and degree of parallelization. As mentioned, the multiplications are taken into account hereinafter as crucial operations affecting the complexity.

The multiplication of two integers of the word length n and m can be described as follows. Let there be two integers

$$A = {A}_{n - 1} \cdot {W}^{n - 1} + … + {A}_{1} \cdot W + {A}_{0} , where {A}_{i} ∈ [ 0 , W [ , \qquad ( 24 )$$

$$and$$

$$B = {B}_{m - 1} \cdot {W}^{m - 1} + … + {B}_{1} \cdot W + {B}_{0} , where {B}_{j} ∈ [ 0 , W [ . \qquad ( 25 )$$

If these are multiplied together, then the following holds true

$$A \cdot B = {\sum }_{i := 0}^{n - 1} {\sum }_{j := 0}^{m - 1} {A}_{i} \cdot {B}_{j} \cdot {W}^{i + j} . \qquad ( 26 )$$

This multiplication has the complexity of (n·m). In this case, only the relevant elementary multiplications Aᵢ·Bⱼ are counted here by way of example. The products with W are merely address manipulations and are initially not taken into account in the complexity.

The complexity of step 2 is (m+1)² and the complexity of step 3 is m². Overall, this results in a complexity of 2m²+2m+1.

The entire modular multiplication with Barrett reduction thus has a complexity of 3m²+2m+1.

In step 2, a product having a length of 2 (m+1) words is calculated, the upper part of which can be completely discarded. In step 3, the product Q₁·N is calculated, the upper part of which is known to be approximately identical to the upper part of C.

It is noted here that the upper part comprises continuous bits with the most significant bit (MSB). Accordingly, the lower part comprises continuous bits with the least significant bit (LSB). The upper part or the lower part can comprise approximately half of the bits.

### First Optimization of the Barrett Reduction

The known Barrett reduction can be improved as follows: only the upper part of the product is determined in step 2 and only the lower part of the product is determined in step 3. This causes roughly two “half” multiplications, and so steps 2 and 3 together approximately have a complexity of m².

Step 3 can be optimized as follows: instead of

$$D ← C - {Q}_{1} \cdot N$$

the following is calculated

$$D ← ( C - {Q}_{1} \cdot N ) mod {W}^{m + 1} .$$

This is possible because D<3N<W^{m+1}. (W≠2 holds true, by way of example.) Consequently, firstly (Q₁·N)modW^{m+1} is calculated by virtue of the fact that instead of

$${Q}_{1} \cdot N = {\sum }_{i := 0}^{m - 1} {\sum }_{j := 0}^{m - 1} {( {Q}_{1} )}_{i} \cdot {N}_{j} \cdot {W}^{i + j} = {\sum }_{k : = 0}^{2 m - 2} {\sum }_{i + j = k} {( {Q}_{1} )}_{i} \cdot {N}_{j} \cdot {W}^{k}$$

only

$$( {\sum }_{k : = 0}^{m} {\sum }_{i + j = k} {( {Q}_{1} )}_{i} \cdot {N}_{j} \cdot {W}^{k} ) mod {W}^{m + 1}$$

is determined. This contains all parts which are not canceled by mod W^{m+1}. The complexity for this operation amounts to

$$1 + 2 + ⋯ + ( m - 1 ) + m + ( m - 1 ) = \frac{m ( m + 1 )}{2} + m - 1 = \frac{{m}^{2} + 3 m - 2}{2} .$$

Step 2 is considered more closely below since a small error is made here: the calculation of C₂·I₁
where

$${C}_{2} := ⌊ \frac{C}{{W}^{m - 1}} ⌋ = {C}_{1} \cdot W$$

$$and$$

$${I}_{1} = ⌊ \frac{{W}^{2 m}}{N} ⌋$$

is intended to take place only on the upper half since only the upper proportion

$$( {C}_{1} \cdot {I}_{1} ) {divW}^{m + 1}$$

is of interest. Thus, instead of determining

$${C}_{2} \cdot {I}_{1} = {\sum }_{i : = 0}^{m} {\sum }_{j : = 0}^{m} {( {C}_{2} )}_{i} \cdot {( {I}_{1} )}_{j} \cdot {W}^{i + j} = {\sum }_{k : = 0}^{2 m} {\sum }_{i + j = k} {( {C}_{2} )}_{i} \cdot {( {I}_{1} )}_{j} \cdot {W}^{k}$$

what is calculated is only

$${\sum }_{k : = m - 1}^{2 m} {\sum }_{i + j = k} {( {C}_{2} )}_{i} \cdot {( {I}_{1} )}_{j} \cdot {W}^{k}$$

$$or$$

$${q}_{2} := \frac{{\sum }_{k := m - 1}^{2 m} {\sum }_{i + j = k} {( {C}_{2} )}_{i} \cdot {( {I}_{1} )}_{j} \cdot {W}^{k}}{{W}^{m + 1}} ,$$

wherein Q₂:=└q₂┘ is set and the corresponding operation in step 3 is replaced by

$$D ← C - {Q}_{2} \cdot N .$$

All partial products with at least the factor W^{m+1} are required in the result. Furthermore, the proportions with the factor W^{m} are also necessary since the associated product (C₂)ᵢ·(I₁)ⱼ has a length of two words. In addition, the proportions with the factor W^{m-1} are also required since (C₂)ᵢ·(I₁)ⱼ·W^{k} may be just below W^{m+1}, and the sum of a plurality of such summands may affect the upper part of the result via carry bits.

The complexity for this operation is

$$1 + 2 + ⋯ + m + ( m + 1 ) + m = \frac{( m + 2 ) ( m + 3 )}{2} - 2 = \frac{{m}^{2} + 5 m + 2}{2} .$$

Overall, this results in a complexity for the Barrett reduction of

$$\frac{{m}^{2} + 3 m - 2}{2} + \frac{{m}^{2} + 5 m + 2}{2} = {m}^{2} + 4 m .$$

On account of an error, the calculated value is somewhat too small, specifically by a value

$${\sum }_{k : = 0}^{m - 2} {\sum }_{i + j = k} {( {C}_{2} )}_{i} \cdot {( {I}_{1} )}_{j} \cdot {W}^{k} < ( m - 1 ) \cdot {W}^{m} .$$

For this reason, the above estimation is corrected by

$$0 \leq q - {q}_{2} = q - {q}_{1} + {q}_{1} - {q}_{2} < \frac{1}{W} \frac{{W}^{m}}{N} + \frac{N}{{W}^{m}} + \frac{m - 1}{W} . \qquad ( 27 )$$

This term can be simplified to

$$0 \leq q - {q}_{2} < 1 + \frac{m}{W} , \qquad ( 28 )$$

that is to say that as long as m≤W, it still holds true that q−q₂<2.

This simplification can be substantiated by the term on the right-hand side being a convex function in the modulus N, on the interval [W^{m-1}, W^{m}]. If N=W^{m-1} and N=W^{m} are set, the simplified term follows.

### Further Optimization of the Barrett Reduction

The traditional Barrett reduction and the optimization described still have potential for improvement:
The end reductions (step 4) may consist only of simple subtractions, but depending on the relationship between the execution time of the elementary multiplications and the corresponding elementary additions (and elementary subtractions), this step cannot always be disregarded: on an architecture with one elementary multiplication executed in one clock cycle, the reduction according to step 4 requires at least m clock cycles. In comparison with the complexity of m₂+4m calculated above, step 4 may already constitute a time proportion in the double-digit percentage range. This applies primarily in cases with a large word width (w=32, 64) and for the application of elliptic curves, where m may be in a range of 4 to 8.
The estimation Q−Q₁≤2 or Q−Q₂≤2 necessitates providing two end reductions in step 4, which means doubling the execution time in step 4. This primarily affects applications in which a constant execution time is desired.

With the aid of equations (17) to (22), it is possible to specify a more extensive optimized variant of the Barrett reduction.

The starting point for this variant is that the calculation of C₁·I₁ is performed with an increased precision.

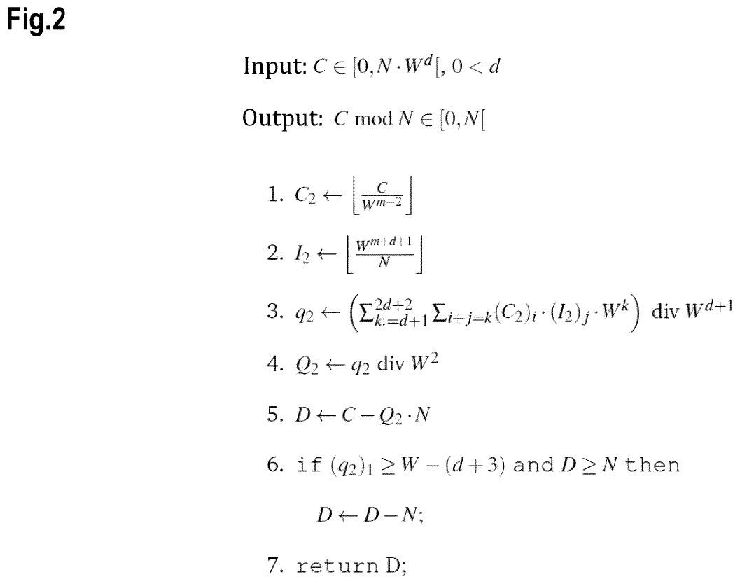

FIG. 2 shows by way of example one implementation of an optimized Barrett reduction for a general d without the preceding multiplication (i.e. without step 1 from FIG. 1). The optimization measures explained above have already been taken into account here.

The following was determined further above:

$${q}_{1} := \frac{{C}_{1} \cdot {I}_{1}}{{W}^{d}}$$

$$where$$

$${C}_{1} := ⌊ \frac{C}{{W}^{m - 2}} ⌋ \cdot \frac{1}{{W}^{2}}$$

$$and$$

$$⌊ \frac{{W}^{m + d + 1}}{N} ⌋ \cdot \frac{1}{W}$$

such that

$$q - {q}_{1} < \frac{2}{W}$$

holds true.

With regard to the steps shown in FIG. 2, the following should furthermore be noted:
Step 1: C₂=C₁·W². In this case, C₂ has a maximum length of d+2 words.
Step 2: I₂=I₁·W·I₂ has a length of exactly d+2 words and may be precalculated.
Step 3: q₂ is an integral approximation of

$$\frac{{C}_{2} \cdot {I}_{2}}{{W}^{d + 1}} = {q}_{1} \cdot {W}^{2} .$$

In step 3, C₂ consists of a maximum of d+2 words and I₂ consists of exactly d+2 words, i.e. it holds true that: 0≤i, j≤d+1.

Step 4: Q₂ is an approximation of Q₁ or Q.

Step 5: the optimizations described above can be applied here.

Step 6: it holds true that

$${( {q}_{2} )}_{1} = ( {q}_{1} mod {W}^{2} ) d i v W .$$

This will be explained in further detail below.

The error in step 3 can be estimated by

$$0 \leq {q}_{1} - \frac{{q}_{2}}{{W}^{2}} < \frac{d + 1}{W} \qquad ( 29 )$$

and overall this results in

$$0 \leq q - \frac{{q}_{2}}{{W}^{2}} < \frac{2}{W} + \frac{d + 1}{W} < \frac{d + 3}{W} . \qquad ( 30 )$$

The first part follows directly:

$$\begin{matrix}{q}_{1} \cdot {W}^{d + 3} - {q}_{2} \cdot {W}^{d + 1} = {C}_{1} \cdot {I}_{1} \cdot {W}^{3} - {q}_{2} \cdot {W}^{d + 1} \\ = ⌊ \frac{C}{{W}^{m - 2}} ⌋ \cdot ⌊ \frac{{W}^{m + d + 1}}{N} ⌋ - {q}_{2} \cdot {W}^{d + 1} \\ = {C}_{2} \cdot {I}_{2} - {q}_{2} \cdot {W}^{d + 1} \\ = {\sum }_{k = 0}^{d} {\sum }_{i + j = k} {( {C}_{2} )}_{i} \cdot {( {I}_{2} )}_{j} \cdot {W}^{k} \\ < ( d + 1 ) ⋅ {W}^{d + 2}\end{matrix}$$

In the inequality, (C₂)ᵢ, (I₂)ⱼ are estimated with (W−1). The second part follows from the explanations above.

If

$$δ = \frac{d + 3}{W}$$

is applied in conjunction with equation (20) and if in the algorithm

$${q}_{2} mod {W}^{2} < {W}^{2} - ( d + 3 ) \cdot W \qquad ( 31 )$$

then it holds true that

$$Q = {Q}_{2} .$$

This is substantiated by the fact that

$$\frac{{q}_{2} mod {W}^{2}}{{W}^{2}}$$

is a fraction of q₂.

This also yields the substantiation for step 6: if the above inequality is satisfied, then the result is Q=Q₁. An end reduction is no longer necessary.

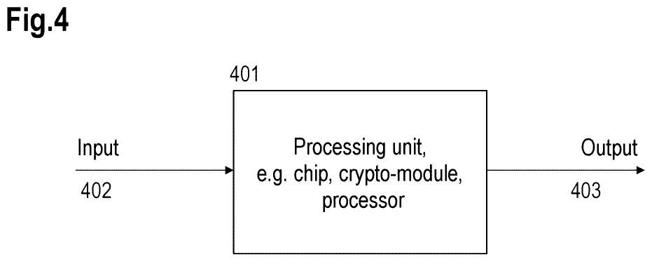

The optimized Barrett reduction described here may generally be referred to as modular reduction. FIG. 4 shows by way of example an arrangement comprising a processing unit 401, which by way of example receives an input 402, performs a cryptographic method, e.g. an encryption, a decryption, a signature creation or a signature verification, and provides a corresponding output 403 (e.g. encrypted data, decrypted data, signature, verify signature, error, etc.) as the result. The processing unit 401 can be embodied as a chip, a crypto-module or a processor or can comprise at least a chip, a crypto-module and/or a processor. The cryptographic method performed on the processing unit 401 uses modular multiplications. The modular reduction described here can be used in the context of the modular multiplication.

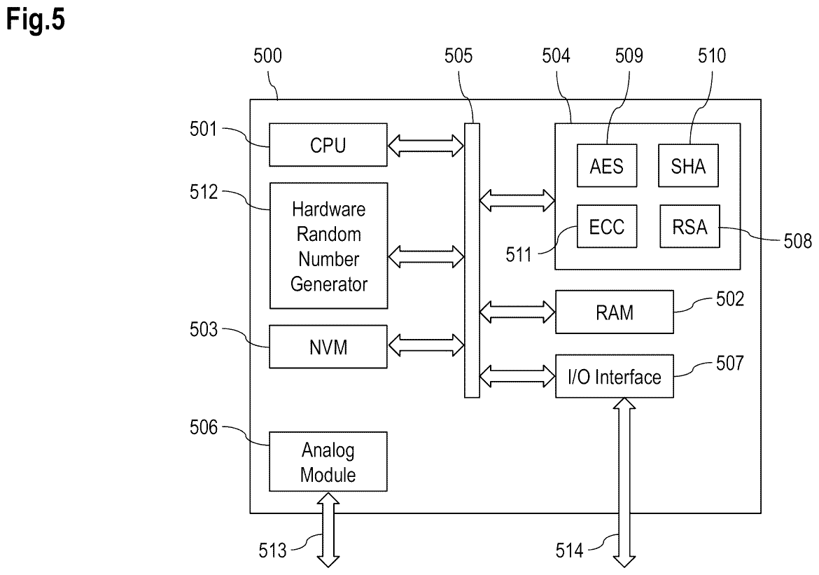

FIG. 5 shows a processing device 500 comprising a CPU 501, a RAM 502, a nonvolatile memory 503 (NVM), a crypto-module 504, an analog module 506, an input/output interface 507 and a hardware random number generator 512.

In this example, the CPU 501 has access to at least one crypto-module 504 via a common bus 505, to which each crypto-module 504 is connected. Each crypto-module 504 can comprise in particular one or more crypto-cores in order to perform specific cryptographic operations. Exemplary crypto-cores are:
an AES core 509 (AES: Advanced Encryption Standard),
an SHA core 510 (SHA: Secure Hash Algorithm),
an ECC core 511 (ECC: Error Checking and Correcting), and
an RSA core 508 (RSA: Rivest-Shamir-Adleman, relates to a core that implements the RSA algorithm).

The CPU 501, the hardware random number generator 512, the NVM 503, the crypto-module 504, the RAM 502 and the input/output interface 507 are connected to the bus 505. The input/output interface 507 may be connected to other devices that may be similar to the processing device 500.

The crypto-module 504 can be equipped with or without hardware-based security features.

The bus 505 itself can be masked or open. The instructions for performing the steps described here can in particular be stored in the NVM 503 and be processed by the CPU 501. The processed data can be stored in the NVM 503 or in the RAM 502. Supporting functions can be provided by the crypto-modules 504.

The steps of the method described here can be performed exclusively or at least partly on the crypto-module 504. In particular, at least one modular multiplication comprising the modular reduction described here can be performed on the crypto-module 504.

In one example, long number multiplications can be performed in the crypto-module 504 or at least partly in the CPU 501. In another example, non-modular integer multiplications are always carried out in the crypto-module 504.

By way of example, the processing device 500 can be a smart card that is operated by direct electrical contact or by an electromagnetic field. The processing device 500 can be a fixed circuit or can be based on reconfigurable hardware (e.g. field programmable gate array, FPGA). The processing device 500 can be connected to a personal computer, a microcontroller, an FPGA or a smartphone. Alternatively, the processing device 500 can be embodied as a crypto-core, a hardware security module (HSM) or some other hardware module.

### Complexity of the Optimized Barrett Reduction

For the complexity of the optimized Barrett reduction, the elementary multiplications in steps 3 and 5 are counted. In step 3 this results in a complexity of

$$1 + … + d + ( d + 1 ) + ( d + 2 ) = \frac{( d + 2 ) ( d + 3 )}{2} \qquad ( 32 )$$

In step 5, for the case (q2)1<W−d−3, the product Q2. N only has to be calculated modulo Wm, i.e.,

$${Q}_{2} \cdot N mod {W}^{m} = {\sum }_{i := 0}^{d - 1} {\sum }_{j := 0}^{m - 1} {( {Q}_{2} )}_{i} \cdot {N}_{j} \cdot {W}^{i + j} mod {W}^{m} \qquad ( 33 )$$

$$= {\sum }_{k : = 0}^{m - 1} {\sum }_{i + j = k} {( {Q}_{2} )}_{i} \cdot {N}_{j} \cdot {W}^{k} mod {W}^{m} \qquad ( 34 )$$

For d≤m, this therefore results in a complexity of

$$m + ( m - 1 ) + … + ( m - ( d - 1 ) ) = d \cdot m - \frac{( d - 1 ) \cdot d}{2} . \qquad ( 35 )$$

and specifically in the case d=m the complexity amounts to

$$m + ( m - 1 ) + … + 1 = \frac{m \cdot ( m + 1 )}{2} . \qquad ( 36 )$$

In the case (q₂)₁≤W−d−3, this value increases somewhat, but that case statistically occurs very infrequently.

In the case d=m, the resulting overall complexity is

$$\frac{( m + 2 ) ( m + 3 )}{2} + \frac{m ( m + 1 )}{2} = {m}^{2} + 3 m + 3 . \qquad ( 37 )$$

### Further Advantages

A clear advantage of this optimized variant of the Barrett reduction is that an end reduction is completely dispensable in most cases. Furthermore, these very infrequent cases can be detected, specifically already at a time when the provisional result of D is not yet available.

In the Barrett reduction according to the prior art, up to two operations (end reductions)

$$D ← D - N$$

are necessary because the Q₁ calculated there may deviate from the exact value Q by up to 2. For a statistically distributed input, the three cases Q−Q₁=0, 1, 2 often occur.

This can be used for side channel attacks. Since each operation D←D−N is recognizable in the current profile, in security-critical applications the user is forced to carry out both end reductions, at least as dummy operations. Otherwise, an attacker could directly deduce the value Q−Q₁=0, 1, 2 from the number of end reductions.

Since each of these end reductions requires at least m clock cycles, such an end reduction with dummy operations causes a contribution of 2m clock cycles to the total execution time.

By contrast, the solution described here for the optimized Barrett reduction makes it possible for there to be only a very low probability of the occurrence of the end reduction for generic, i.e. random, inputs: as explained above, the probability of an end reduction is in a range (d+3)/W, or (m+3)/W. For an architecture having the width (w equals 32 or 64) and practical values of d<2⁸, this probability is approximately 2⁻²⁴ or 2⁻⁵⁶. Precisely in the last case, the probability is so low that the case of a necessary end reduction practically never occurs, at least not for random values. For this reason, it is possible to dispense with the implementation of a dummy end reduction for avoiding successful side channel attacks.

In order to explain a further advantage, firstly the complexity for the end reduction (primarily in the traditional case of the Barrett reduction) is estimated. By way of example, a concrete implementation of the algorithm is considered for this purpose: in most cases there is a platform having a RAM area and an internal register area. The concrete calculations take place on the registers, but the inputs and outputs are stored in the RAM. Therefore, the inputs and outputs first have to be moved back and forth between the RAM and the registers in order to be able to use them for computation. Loading and storage operations are incurred here. In some platforms it is possible for a subtraction in D−Q·N to proceed completely in the background during the multiplication Q·N. Writing back the result can also be implemented such that this proceeds during the calculation. However, this works only if it is known that the result of D−Q·N is also the result of the overall operation.

Before an end reduction, normally a decision needs to be taken as to whether this is also really necessary. In this regard, the operation D←D−N is necessary only if D≥N.

This can be ascertained by calculating D-N and checking whether the value is negative or not. However, this necessitates already having performed the actual complex operation of subtraction. Consequently, overall the following steps have to be carried out:
1. D←D−N
2. If D′<0, D is returned as the result.
3. Otherwise, D′ is returned as the result.

The decision as to which value is returned is not certain until in step 2. For this reason, the routine with the return does not simply need m clock cycles, but rather 2m clock cycles. If the result from step 2 were already known at the beginning of step 1, then the result D or D′ could already be returned in parallel with the calculation in step 1. However, that does not work in the known Barrett reduction.

By contrast, this is however possible in the optimized Barrett reduction described here, since in almost all cases it is known that the result calculated with C−Q₂N is already the correct result. Consequently, this result can already be written back during the calculation.

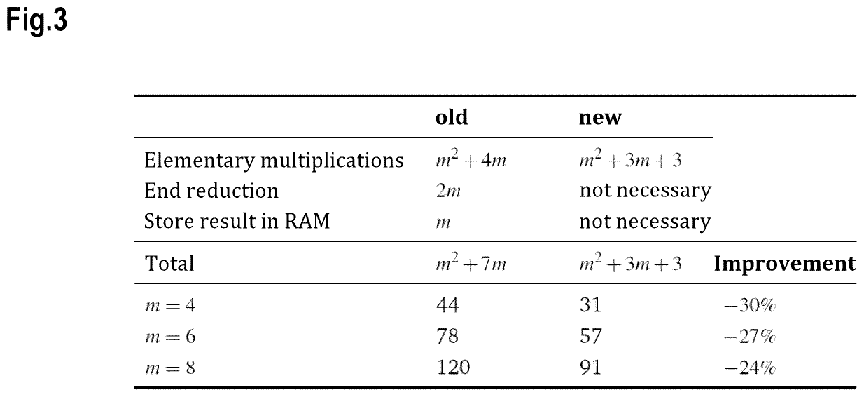

For the following estimations or comparisons, it is assumed by way of example that all elementary operations each require one clock cycle. Furthermore, it is assumed that the additions or subtractions within the complex operations proceed neutrally in terms of time. Writing back the result is likewise estimated at one clock cycle per word. FIG. 3 shows a table illustrating the advantages of the Barrett reduction described here compared with the known Barrett reduction for various values of m.

1. A device for performing a modular reduction of an input number C modulo of a modulus N, wherein the device comprises a processing unit, the processing unit comprising processing circuitry and memory, the processing unit being configured to:
calculate an intermediate value q, from which a quotient of the input number C divided by the modulus N is approximated,
extract a number Q for a reduction operation C−Q·N from the intermediate value q,
extract information from the intermediate value q, wherein on the basis of the information prior to performing the reduction operation C−Q·N it is possible to determine whether a final reduction is to be performed,
perform the reduction operation C−Q·N,
depending on the information, perform the final reduction or not perform the final reduction.

2. The device of claim 1, wherein the processing unit is configured to perform a cryptographic operation, the cryptographic operation comprising one or more of any one or more of: an encryption, a decryption, a signature creation, and a signature verification.

3. The device of claim 1, wherein the processing unit comprises one of the following or is embodied as one of the following:
a processor,
a chip,
a crypto-module.

4. The device of claim 1, wherein the processing unit is configured to carry out the modular reduction as part of a modular multiplication.

5. The device of claim 1,
wherein the modulus N has a number of m words and the input number C is at most 0<d words longer than the modulus N,
wherein the intermediate value q is determined by calculating elementary products Ci and Ij where i+j>m+d−1, wherein Ci is an i-valued word from the input number C and Ij is a j-valued word from a value I, wherein the value I is determined according to Wm+d+1/N or an integral multiple thereof, wherein W=2ⁿ holds true and n is a word width.

6. The device of claim 1, wherein the processing unit is configured to extract the information, wherein the information corresponds to a Boolean value of the logical condition q1≥W−d−3 or or of a logically weaker.

7. The device of claim 6, wherein the processing unit is configured to perform the final reduction if the Boolean value of the logical condition or of the the logically weaker condition is true.

8. A method for performing a modular reduction of an input number C modulo of a modulus N, comprising the steps of:
calculating an intermediate value q, from which a quotient of the input number C is approximated by the modulus N,
extracting a number Q for a reduction operation C−Q·N from the intermediate value q,
extracting information from the intermediate value q, wherein on the basis of the information already before performing the reduction operation C=Q·N it is possible to determine whether a final reduction is to be performed,
performing the reduction operation C−Q·N, and
depending on the information, performing the final reduction or not performing the final reduction.

9. The method of claim 8, wherein the modular reduction is performed as part of a modular multiplication.

10. The method of claim 8,
wherein the modulus N has a number of m words and the input number C is at most 0<d words longer than the modulus N,
wherein the intermediate value q is determined by calculating elementary products Ci and Ij where i+j>m+d−1, wherein Ci is an i-valued word from the input number C and Ij is a j-valued word from a value I, wherein the value I is determined according to Wm+d+1/N or an integral multiple thereof, wherein W=2ⁿ holds true and n is a word width.

11. The method of claim 8, wherein the information corresponds to a Boolean value of the logical condition q1≥W−d−3 or of a logically weaker condition.

12. The method of claim 11, wherein the final reduction is performed if the Boolean value is true.

13. The method of claim 8, wherein the modular reduction is used in a cryptographic method or a cryptographic system.

14. The method of claim 8, wherein the modular reduction is performed in the context of a cryptographic operation comprising at least one of any one or more of:
an encryption,
a decryption,
a signature creation, and
a signature verification.
